(19) United States
(12) Patent Application Publication
(10) Pub. No.: US 2019/0275770 A1
(43) Pub. Date: Sep. 12, 2019

(54) FOAM AND SKINNED GASKETS AND TAPE WITH FLAME RETARDANT, SMOKE DENSITY AND TOXICITY LIMITS

(71) Applicant: THE PATENT WELL LLC, Fort Worth, TX (US)

(72) Inventors: Jeff Busby, Millsap, TX (US); Matt Boyd, Fort Worth, TX (US); Kent Boomer, Alvedo, TX (US); Chad Knight, Dodd City, TX (US); Peter Sibello, Benbrook, TX (US); Michael Dry, Fort Worth, TX (US)

(21) Appl. No.: 16/294,331

(22) Filed: Mar. 6, 2019

Related U.S. Application Data
(60) Provisional application No. 62/639,288, filed on Mar. 6, 2018.

(51) Int. Cl. B32B 27/06; B32B 27/32; B32B 27/40

(52) U.S. Cl. CPC B32B 27/065; B32B 27/322; B32B 27/40; C08L 27/18; B32B 2266/02; B32B 2605/18; B32B 2556/00; B32B 2266/12

(57) ABSTRACT

Applicant discloses multiple embodiments of a non-adhesive cured two-part polymer sealant for use on aircraft parts. In some embodiments, the sealant comprises only a carrier and a cured polymer gel. In some embodiments, the carrier of the sealant is at least partially open cell foam, which at least partially absorbs a cured polymer gel, and which sealant has beneficial properties, including low smoke density, non-toxicity when burned, and flame retardant properties. In some embodiments, the sealant comprises a skin on an outer surface thereof, which skin may be impermeable or semi-permeable to the passage of liquids and or polymer gels. In some embodiments, the sealant is breathable but moisture-proof.

This application claims priority to and the benefit of, and incorporates by reference U.S. Application No. 62/639,288, filed Mar. 6, 2018. Incorporated herein by reference are the following: U.S. Pat. Nos. 6,530,577; 6,695,320; 7,229,516; 8,769,965; application Ser. No. 14/484,570, filed Sep. 12, 2014; and Ser. No. 15/697,266, filed Sep. 6, 2017.

Also incorporated hereby by reference are the following: U.S. Application No. 62/526,248, filed Jun. 28, 2017; U.S. Pat. Nos. 8,633,402; 8,652,362; and US Publication Nos. 2004/0041356; 2004/0070156; 2004/0041356; 2005/0109190; 2013/0224434; and 2013/0168612.

### FIELD OF THE INVENTION

A gasket material for positioning between a workpiece and a base, more specifically, a gasket material having, in some embodiments, a foam core and a tacky, cured polyurethane gel.

### BACKGROUND OF THE INVENTION

A gasket is a sealing member for use between two mating surfaces to help prevent the movement of fluid or gas between the mating surfaces. They are often used in vehicles, such as aircraft, to prevent moisture from corroding the sealed off areas and the mating surfaces. They may be used in one embodiment for sealing between an aircraft antenna and the outer skin of the aircraft or, in another embodiment, between floorboards and stringers on an aircraft interior.

Gaskets may be provided for covering a portion of the “footprint” of the antenna or other workpiece against another part of the aircraft. When the fasteners are tightened down, they compress the gasket typically with some deformation (decrease in thickness) or gasket “squeeze out”, between the workpiece and the other aircraft part. This is done in an effort to prevent moisture from penetrating the gasket barrier.

However, some prior art gaskets have a number of short-comings which Applicant's novel gasket material overcomes. These shortcomings include allowing moisture to penetrate the area between the workpiece and the base. Sometimes, for example, a common site of corrosion is the junction between the antenna inner surface and the electrical connective elements of the antenna. Moisture has been found to “pool” in this area, accelerating corrosion. Further shortcomings of the prior art gaskets include their moisture content or moisture absorption ability, which moisture may encourage the formation of corrosion, when the gasket is under pressure between the mating surfaces and, especially, where such gasket includes a metallic element. Further shortcomings of the prior art gaskets include their “non-selective retentivity.” This means that after the gasket has been installed and in use for a period of time, that upon an attempt to separate the antenna from the aircraft's skin, some portions of the gasket will non-selectively stick to portions of the aircraft's skin and other portions of the gasket will stick to the antenna. The result, sometimes, is the destruction of the gasket.

All of these beneficial properties should have a useful life that is reasonable in view of aircraft operating conditions (repeated temperature and pressure cycling) and aircraft maintenance schedules. The gasket or tape should be inert, that is non-reactive with the work pieces (typically aluminum) as well as non-reactive to water, including salt water and non-reactive to fluids found in an aircraft.

### SUMMARY OF THE INVENTION

In some embodiments, a sealant in the form of a gasket or tape is provided that passes either one, some or all of smoke density, fire retardant, and/or smoke toxicity, and is non-stretchable. It may have a tacky gel body and a carrier. It may have a skin which may be porous (semi-permeable), which skin may be on one, both or some of the outer surfaces of the tape. The carrier or the skin, or both, may be stretchable or non-stretchable. A skin is typically on the top or bottom of the sealant and contacting a workpiece and/or base. It is typically thin, in the nature of 1 to 4 mil, as compared to carriers which are typically thicker and whose primary function is to adhere to and hold the gel and provide some structure to the sealant.

Applicant discloses a gasket or tape with a novel combination of properties and qualities that effectively prevent moisture from passing a sealed area while maintaining sufficient retentivity of a gel to an aircraft part. This allows the effective and non-destructive separation between the mating surfaces upon removal of an aircraft part from another aircraft part. Flexibility, resiliency, compressibility and pliability are other favorable properties which help affect a good seal between the mating surfaces.

Not surprisingly, it has proven a challenge to develop a gasket or tape with these properties that will survive repeated heat and pressure cycling (as the aircraft climbs and descends), structural flexing, and vibration while protecting the aircraft components and having a useful life.

Applicant, however, provides for the above beneficial properties in a novel aircraft gasket and tape and a novel method of manufacturing the aircraft gasket and tape. Tape is gasket material that is rolled into tape rather than precut to the pattern of the mating surfaces. Applicant further provides for a method of using the preformed gasket with a liquid settable gel to help insure a waterproof seal.

In some embodiment, Applicant provides a gasket with the following beneficial properties, in a preformed gasket or a tape: elasticity (with memory), low water absorption, low water content, leak free (especially of silicon oil), desiccation resistant, compressibility, reusability, and surface tackiness (including selective retentivity).

Elasticity and pliability help make an effective seal between the two mating surface as compression against such elasticity helps seal over mating surface irregularities and structural flexing or vibration of the two surfaces. The maintenance of this elasticity property is important since the surfaces undergo thermal expansion and contraction during repeated altitude and temperature changes which causes relative movement (flexing) between the mating surfaces.

Low water absorption and low water content is also a beneficial quality as it is typically water or moisture that the gasket is meant to keep out. Nor should a gasket material itself be the source of oil, as such oil can mar the finish of the aircraft surface. Oil leaching has been a problem with prior art gaskets including those silicon-based gaskets.

An additional beneficial property of an effective gasket includes a resistance to drying out. Drying out of a gasket brings the problem of shrinkage and break-up, which may destroy the integrity of the gasket/mating surface.

Tackiness or stickiness, work of adhesion and peel strength, within selected ranges, have been found beneficial since there is also vibration and flexing of the mating surfaces. These properties may provide an improved seal should there be a slight separation between the mating surfaces.

In some embodiments, Applicant provides a gasket comprising a first cellular foam carrier having an upper surface and a lower surface and a body between the upper and lower surface, the foam carrier in an uncompressed condition between about 20 mil and 250 mil thick; a cured polyurethane gel layer on the upper and/or lower surfaces, the cured polyurethane gel layer at least partly penetrating the body of the foam carrier. Each of the gel layers may be between about 2 mil and 20 mil thick; and a moisture impervious layer, such as a PTFE layer, on top of one of either the upper or lower surfaces of the cured polyurethane layer. The gasket, in one embodiment, is between about 20 and 500 mil thick (uncompressed). The body of the foam carrier may have an upper portion and a lower portion, with a polyurethane gel layer between the upper and lower portions. There may be a skeletal member between the upper and lower portions.

In one embodiment, an at least partly open cell foam carrier is laminated on one side with any of the non-stretch skins disclosed herein and a second side is at least partly an open cell foam, the laminated carrier at least partly saturated with polyurethane gel or other polymer. The skin may be pervious, partly pervious or non-pervious to the gel.

A non-adhesive sealant is disclosed comprising, in some embodiments, either an at least partially open cell foam carrier or a woven fiberglass carrier, the carrier having an upper surface and a lower surface and a body between the upper and lower surface; a cured, tacky, gel layer on at least one of the upper and lower surfaces of the carrier, the cured polyurethane gel layer at least partly penetrating the carrier body, and, in some embodiments, a skin engaging the carrier; wherein the sealant has a smoke density of 200 maximum at about 4.0 minutes under AITM2-0007A, Issue 3.

A non-adhesive sealant is disclosed comprising, in some embodiments, either an at least partially open cell foam carrier or a woven fiberglass carrier, the carrier having an upper surface and a lower surface and a body between the upper and lower surface; a cured, tacky, gel layer on at least one of the upper and lower surfaces of the carrier, the cured polyurethane gel layer at least partly penetrating the body, and, in some embodiments, a skin engaging the foam carrier; wherein the sealant has toxicity limits of less than about: 150 PPM HCN, 1000 PPM CO, 100 PPM NO/NO2, 100 PPM SO2, 100 PPM HF, and 150 PPM HCl under AITM 3-0005, Issue 2.

A non-adhesive sealant is disclosed comprising, in some embodiments, either an at least partially open cell foam carrier or a woven fiberglass carrier, the carrier having an upper surface and a lower surface and a body between the upper and lower surface; a cured, tacky, gel layer on at least one of the upper and lower surfaces of the carrier, the cured polyurethane gel layer at least partly penetrating the body of the carrier, and, in some embodiments, a dimensionally stable, substantially non-stretchable (less than about 10%) layer engaging the foam carrier; wherein the sealant passes 12 second vertical burn test according to 14 CFR, Part 25—Subpart D, § 25.853(a) compartment interiors.

An assembly of aircraft parts is disclosed comprising, in some embodiments, a first workpiece; a second workpiece; a sealant comprising: a carrier having an upper surface and a lower surface and a body between the upper and lower surface, the carrier between about 10 mil and 250 mil thick; a non-adhesive, cured tacky gel layer on at least one of the upper and lower surfaces of the carrier, the cured, tacky gel layer at least partly penetrating the carrier; and a non-stretchable substantially moisture proof (under compression) skin on top of at least one of either the upper or lower surfaces of the cured tacky gel layer, the sealant having at least one fire resistant property and being resistant to degradation when exposed to Jet A fuel and/or aircraft hydraulic fluid.

An assembly of aircraft parts is disclosed comprising, in some embodiments, a first workpiece; a second workpiece; a cellular foam carrier having an upper surface and a lower surface and a carrier body between the upper and lower surface; a non-adhesive cured, tacky gel layer on at least one of the upper and lower surfaces of the foam carrier, some of the cured gel layer at least partly penetrating the body of the carrier; and a dimensionally stable layer.

A non-adhesive sealant is disclosed comprising, in some embodiments, a body and a non-stretchable, woven fiberglass skeleton encapsulated by the body: the body comprising a non-adhesive, cured, tacky, soft, deformable gel, the gel body having an upper surface, a lower surface, and a perimeter, wherein the upper and lower surfaces of the gel body, in an uncompressed state, define a body thickness; the skeleton comprising multiple openings for encapsulation by the gel body, the skeleton having an upper surface, a lower surface, and a perimeter; the sealant in an uncompressed state dimensioned to fit in a first opening between a wall and an aircraft component surface and deformable when under compression to fit in a second opening, smaller than the first opening; wherein the sealant is fireworthy.

A device for providing an environmental seal to an aircraft assembly is disclosed comprising, in some embodiments, a first part and a spaced apart second part, the two parts forming a gap, the device comprising: a sealant comprising a skeleton and a body encapsulating the skeleton, wherein the body is comprised of a cured polyurethane gel, resulting from a mix of a polyol and isocyanate, the sealant having fireworthiness properties and passing the following tests: wherein the sealant has toxicity limits of less than about: 150 PPM HCN, 1000 PPM CO, 100 PPM NO/NO2, 100 PPM SO2, 100 PPM HF, and 150 PPM HCl under AITM 3-0005, Issue 2; wherein the sealant passes 12 second vertical burn test according to 14 CFR, Part 25—Subpart D, § 25.853(a) compartment interiors; wherein the sealant has a smoke density of Ds maximum at about 4.0 min. of under 200 AITM2-0007A, Issue 3; wherein the skeleton is comprised of a molded or extruded web or fiberglass mesh having a thickness less than about 0.033″; and the body having a tackiness of between 5 and 50 psi; and wherein the volume of gel/skeleton ratio of the sealant is in the range of about 3/1 to 7/1. [24] A method for releasably, environmentally sealing a pair of opposing, gap forming, fastener engaging surfaces of aircraft parts is disclosed, the method, in some embodiments, comprising the steps of: providing an non-adhesive elastomeric, tacky sealant having a layer of polyurethane gel encapsulating a non-stretchable skeleton, the sealant having fireworthiness properties; placing the sealant in the gap between the surfaces; and compressing the opposing surfaces by tightening the fasteners, and closing the gap contacting the sealant, thereby providing a substantially fluid and air tight seal between the opposed mating surfaces with the sealant substantially filling the gap.

A method of installation with fasteners of a floorboard on floorboard support stringers, the floorboard and stringers having spaced apart fastener holes in and alignable fastener spacing pattern is disclosed, the method, in some embodiments, comprising the steps of: providing an elastomeric, deformable, substantially non-stretchable tape having a tacky, polyurethane gel body and a carrier, the carrier having a top and bottom surface, the carrier at least partially saturated with or encapsulated with the gel of the gel body and having some gel on the top and bottom surface thereof, and a skin, the skin being at least semi-porous to the gel when the tape is under compression, the skin on a top of the carrier, a top surface of the skin being dry or moist when the tape is in an uncompressed condition, the bottom surface of the skin in contact with the gel and adjacent the top surface of the carrier, wherein the gel covered bottom surface of the carrier forms the bottom of the tape and for contacting a stringer when the tape is ready for installation; cutting the tape to a floorboard edge length, the floorboard edge length spanning at least one fastener hole; aligning the cut tape with a stringer having at least one fastener hole; placing the tape, without stretching it, bottom sticky side down on the stringer; placing the floorboard on top of the tape; aligning the hole in the floorboard with the hole in the stringer; punching a hole through the skin of the tape and the carrier at the aligned holes; inserting a fastener through the aligned holes and punched tape; compressing the tape by tightening the fasteners; and allowing some seepage of the gel through the skin of the tape such that some of the gel permeates the skin and contacts the underside of the floorboard and provides an environmental seal.

A non-adhesive sealant for installation with fasteners between a floorboard and floorboard support stringers is disclosed, the floorboard and stringers having spaced apart fastener holes in and alignable fastener spacing pattern, the sealant comprising, in some embodiments, an elastomeric, deformable, substantially non-stretchable tape having a tacky, polyurethane gel body and a carrier, the carrier having a top and bottom surface, the carrier at least partially saturated with or encapsulated with the gel of the gel body and having some gel on the top and bottom surface thereof, and a skin, the skin being at least semi-porous to the gel when the tape is under compression, the skin on a top of the carrier, a top surface of the skin being dry or moist when the tape is in an uncompressed, uninstalled condition, the bottom surface of the skin in contact with the gel and adjacent the top surface of the carrier, wherein the gel covered bottom surface of the carrier forms the bottom of the tape and for contacting a stringer when the tape is ready for installation;

wherein, under compression for at least 60 minutes under 30 to 300 psi, some seepage of the gel through the skin of the tape occurs such that the gel contacts the underside of the floorboard and provides an environmental seal, when the sealant has the following properties: flame retardant, non-toxic, and/or low smoke density.

A non-adhesive sealant is disclosed comprising, in some embodiments, an at least partially open cell foam carrier having an upper surface and a lower surface and a foam body between the upper and lower surface; a cured, tacky, gel layer on at least one of the upper and lower surfaces of the foam carrier, the cured polyurethane gel layer at least partly penetrating the foam body, and a non-stretchable skin engaging the foam carrier; wherein the sealant has a smoke density of 200 maximum at about 4.0 minutes under AITM2-0007A, Issue 3.

A non-adhesive sealant is disclosed comprising, in some embodiments, an at least partially open cell foam carrier having an upper surface and a lower surface and a foam body between the upper and lower surface; a cured, tacky, gel layer on at least one of the upper and lower surfaces of the foam carrier, the cured polyurethane gel layer at least partly penetrating the foam body, and a skin engaging the foam carrier; wherein the sealant has toxicity limits of less than about: 150 PPM HCN, 1000 PPM CO, 100 PPM NO/NO2, 100 PPM SO2, 100 PPM HF, and 150 PPM HCl under AITM 3-0005, Issue 2.

A non-adhesive sealant is disclosed comprising, in some embodiments, an at least partially open cell foam carrier having an upper surface and a lower surface and a body between the upper and lower surface; a cured, tacky, gel layer on at least one of the upper and lower surfaces of the foam carrier, the cured polyurethane gel layer at least partly penetrating the body of the foam carrier, and a non-stretchable (less than about 10%) skin engaging the foam carrier; wherein the sealant passes 12 second vertical burn test according to 14 CFR, Part 25—Subpart D, § 25.853(a) compartment interiors; wherein the gel is polyurethane; wherein the sealant has a tackiness between 5 and 50 psi; wherein the foam carrier is comprised of a first section and a second section.

A non-adhesive sealant is disclosed with a polyurethane gel layer between two sections; wherein there is a skeletal member between two foam carriers; wherein there is a skeletal member or solid sheet adjacent the foam carrier; wherein a dimensionally stable layer is porous or non-porous PTFE; wherein the foam is nylon or polypropylene; wherein the foam is one of: open cell foam; partially open cell foam; reticulated foam.

A sealant including a skeletal member is disclosed; wherein the skeletal member is in contact with a foam carrier and a gel layer, and wherein the skeletal member is substantially encapsulated in the gel; wherein the skeletal member comprises a molded woven nylon or fiberglass; wherein the gel includes multiple small electrically conductive particles; wherein at least some of the particles are graphene or at least some of the particles are metal and coated with a metal oxide which is derived from a trivalent chromium compound and a hexafluorozirconate; or at least some of the particles are metal particles and comprise one or more of aluminum, nickel, zinc, silver, gold, magnesium, copper, iron.

A sealant is disclosed including a sheet located within a foam body having a gel thereon; in some embodiments, the sealant is fluid resistant to Skydrol and/or Jet A fuel; the sealant has a tackiness between 5 and 50 psi measured on the surface with the gel; wherein the sealant has a hardness of between about 40 and 150 measured on the surface with a 35 gr. half cone penetrometer.

An assembly of aircraft parts is disclosed comprising, in some embodiments, a first workpiece; a second workpiece; a sealant comprising a carrier having an upper surface and a lower surface and a body between the upper and lower surface, the carrier between about 10 mil and 250 mil thick; a non-adhesive, cured tacky gel layer on at least one of the upper and lower surfaces of the carrier, the cured, tacky gel layer at least partly penetrating the carrier; and a non-stretchable substantially moisture proof (under compression) skin on top of at least one of either the upper or lower surfaces of the cured tacky gel layer.

An assembly of aircraft parts is disclosed comprising, in some embodiments, a first workpiece; a second workpiece; a cellular foam carrier having an upper surface and a lower surface and a carrier body between the upper and lower surface; a non-adhesive cured, tacky gel layer on at least one of the upper and lower surfaces of the foam carrier, some of the cured gel layer at least partly penetrating the body of the carrier; and a dimensionally stable layer; wherein the dimensionally stable layer is in contact with the carrier and the gel layer, and wherein the dimensionally stable layer is substantially encapsulated in the gel; wherein at least one of the first or second workpiece is an aircraft access panel.

A non-adhesive sealant is disclosed comprising, in some embodiments, a gel body and a non-stretchable skeleton encapsulated by the gel body, the body comprising a non-adhesive, cured, tacky, soft, deformable gel, the gel body having an upper surface, a lower surface, and a perimeter, wherein the upper and lower surfaces of the gel body, in an uncompressed state, define a body thickness; the skeleton comprising multiple openings for encapsulation by the gel body, the skeleton having an upper surface, a lower surface, and a perimeter; the sealant in an uncompressed state dimensioned to fit between a wall and an aircraft component surface and deformable when under compression; wherein the sealant is fireworthy; wherein the gel is 100% solid (no VOCs); wherein the sealant has a smoke density of 200 maximum at about 4.0 minutes under AITM2-0007A, Issue 3; wherein the sealant has toxicity limits of less than about: 150 PPM HCN, 1000 PPM CO, 100 PPM NO/NO2, 100 PPM SO2, 100 PPM HF, and 150 PPM HCl under AITM 3-0005, Issue 2; wherein the sealant passes 12 second vertical burn test according to 14 CFR, Part 25—Subpart D, § 25.853(a) compartment interiors; wherein the sealant, in some embodiments, comprises a two-part polymer, the first part comprising a polyol and the second part comprising an isocyanate, the two parts when combined curing to form the gel of the gel body, and wherein the skeleton, in some embodiments, is comprised of a nylon, polypropylene, or fiberglass having a thickness less than about 0.033″; wherein the gel body comprises, in some embodiments, a polyurethane gel with a molecular weight range is between about 200 to 20,000; wherein the tackiness, in some embodiments, of the sealant is between about 5 and 50 psi; wherein the sealant, in some embodiments, passes the 3000 hour salt fog test according to ASTMB 117; wherein the body contains no silicone or silicone oil; wherein the sealant, in some embodiments, substantially recovers its original dimensional configuration in less than one minute after 180 days under compression between about 150 and 350 psi; wherein the sealant, in some embodiments, has a smoke density of 200 maximum at 4.0 min. under AITM2-0007A, Issue 3; and/or wherein the sealant, in some embodiments, has toxicity limits of less than about: 150 PPM HCN, 1000 PPM CO, 100 PPM NO/NO2, 100 PPM SO2, 100 PPM HF, and 150 PPM HCl under AITM 3-0005, Issue 2; and/or wherein the sealant, in some embodiments, passes 12 second vertical burn test according to 14 CFR, Part 25—Subpart D, § 25.853(a) compartment interiors; wherein the skeleton, in some embodiments, is either nylon or woven fiberglass and less than about 0.033″ thick; wherein the volume ratio of gel body to skeleton is, in some embodiments, in the range of about 3 to 1 and 7 to 1; wherein the cured hardness of the gel body is between about 40 and 150 measured by 35 gr. cone penetrometer; wherein the gel body, in some embodiments, further includes a corrosion inhibiting composition; wherein the gel body thickness, in some embodiments, is greater than a skeleton thickness; the body gel having a tackiness of between 5 and 50 psi.

A method for releasably, environmentally sealing a pair of opposing, gap forming, fastener engaging surfaces of aircraft parts is disclosed, the method comprising, in some embodiments, the steps of: providing an non-adhesive elastomeric, tacky sealant having a layer of polyurethane gel encapsulating a non-stretchable skeleton, the sealant having fireworthiness properties; placing the sealant in the gap between the surfaces; and compressing the opposing surfaces by tightening the fasteners, and closing the gap contacting the sealant, thereby providing a substantially fluid and air tight seal between the opposed mating surfaces with the sealant substantially filling the gap; wherein the sealant has a smoke density of 200 maximum at 4.0 min. under 200 AITM2-0007A, Issue 3; wherein the sealant has toxicity limits of less than about: 150 PPM HCN, 1000 PPM CO, 100 PPM NO/NO2, 100 PPM SO2, 100 PPM HF, and 150 PPM HCl under AITM 3-0005, Issue 2; and wherein the sealant passes 12 second vertical burn test according to 14 CFR, Part 25—Subpart D, § 25.853(a) compartment interiors; wherein the sealant of the providing step has a tackiness between about 5 and 50 psi; wherein the tightening of the compressing step continues until the sealant visibly deforms; wherein the body comprises a polyurethane gel and the molecular weight range is between about 200 to 20,000; wherein the sealant passes the 3000 hour salt fog test according to ASTMB 117; wherein the body of sealant is deformable under compression; wherein the sealant substantially recovers its original dimensional configuration after 180 days under compression between about 150 and 350 psi; wherein the skeleton is either nylon or woven fiberglass and less than about 0.033″ thick.

A method of installation with fasteners of a floorboard on floorboard support stringers is disclosed, the floorboard and stringers having spaced apart fastener holes in and alignable fastener spacing pattern, the method, in some embodiments, comprising the steps of: providing an elastomeric, deformable, substantially non-stretchable tape having a tacky, polyurethane gel body and a carrier, the carrier having a top and bottom surface, the carrier at least partially saturated with or encapsulated with the gel of the gel body and having some gel on the top and bottom surface thereof, and a skin, the skin being at least semi-porous to the gel when the tape is under compression, the skin on a top of the carrier, a top surface of the skin being dry or moist when the tape is in an uncompressed condition, the bottom surface of the skin in contact with the gel and adjacent the top surface of the carrier, wherein the gel covered bottom surface of the carrier forms the bottom of the tape and for contacting a stringer when the tape is ready for installation; cutting the tape to a floorboard edge length, the floorboard edge length spanning at least one fastener hole; aligning the cut tape with a stringer having at least one fastener hole; placing the tape, without stretching it, bottom sticky side down on the stringer; placing the floorboard on top of the tape; aligning the hole in the floorboard with the hole in the stringer; punching a hole through the skin of the tape and the carrier at the aligned holes; inserting a fastener through the aligned holes and punched tape; compressing the tape by tightening the fasteners; and allowing some seepage of the gel through the skin of the tape such that some of the gel permeates the skin and contacts the underside of the floorboard and provides an environmental seal; wherein the tape of the providing step passes 12 sec. vertical burn test; wherein the tape of the providing step passes one or more of 25 FAR 835 smoke density, smoke toxicity, and flammability; wherein the skin is, in some embodiments, PTFE with holes; wherein the skin is, in some embodiments, non-metallic ripstop nylon; wherein the skin is one of: ripstop nylon (parachute fabric); conventional weave fabrics that are highly hydrophobic and flame resistant; perforated PTFE: porous PTFE; water soluble paper, such as rice paper; other uncoated nylon fabrics that are not woven and ripstop pattern; or porous fabric of any pattern, weave or material; wherein the tack of the bottom surface of the tape is, in some embodiments, between 5 and 50, and the tack of the top surface is less than the bottom surface; wherein the carrier has, in some embodiments, an elongation of 10% or less; wherein the skin has an elongation of 10% or less; wherein the tape has an elongation of 10% or less; wherein the carrier is, in some embodiments, an at least partly open cell foam; wherein the carrier is, in some embodiments, fire retardant woven material; wherein the initial pressure generated by the tightened fasteners is between 30 and 500 psi, and after at least 60 minutes, gel is visible on the top surface of the skin.

A non-adhesive sealant for installation with fasteners between a floorboard and floorboard support stringers is disclosed, the floorboard and stringers having spaced apart fastener holes in and alignable fastener spacing pattern, the sealant, in some embodiments, comprising an elastomeric, deformable, substantially non-stretchable tape having a tacky, polyurethane gel body and a carrier, the carrier having a top and bottom surface, the carrier at least partially saturated with or encapsulated with the gel of the gel body and having some gel on the top and bottom surface thereof, and a skin, the skin being at least semi-porous to the gel when the tape is under compression, the skin on a top of the carrier, a top surface of the skin being dry or moist when the tape is in an uncompressed, uninstalled condition, the bottom surface of the skin in contact with the gel and adjacent the top surface of the carrier, wherein the gel covered bottom surface of the carrier forms the bottom of the tape and for contacting a stringer when the tape is ready for installation; wherein, under compression for at least 60 minutes under 30 to 300 psi, some seepage of the gel through the skin of the tape occurs such that the gel contacts the underside of the floorboard and provides an environmental seal.

### BRIEF DESCRIPTION OF THE DRAWINGS

FIGS. 1, 2, and 3 illustrate exploded cross-sectional views of various embodiments of Applicant's novel gasket/tape.

FIGS. 1A, 2A, and 3A all illustrate cross-sectional views of Applicant's assembled gasket/tape, showing at least some of the ingress of the polyurethane gel onto and at least partially into the foam body of the carrier.

FIGS. 4 and 4A are views of another alternate embodiment of Applicant's invention.

FIGS. 5, 5A, and 5B are views of another alternate embodiment of Applicant's invention.

FIGS. 6, 6A, and 6B are views of a floorboard/stringer assembly that may use one or more embodiments of Applicant's tacky polyurethane sealants

FIG. 7 is an elevational view of a sealant in tape form.

FIG. 8 is an illustration of a flexible reticulated foam.

FIGS. 9A and 9B illustrate an assembly and procedure to test physical characteristics of Applicant's sealant.

FIGS. 10A, 10B, 10C, 10D, and 10E are illustrations of the test apparatus probe engaging the sealant during test for tack, work of adhesion and cohesion.

FIGS. 11A and 11B are graphs of the results of FIGS. 10A-10E tests.

FIG. 12 illustrates one assembly that may use embodiments of Applicant's sealants therewith.

FIGS. 12A and 12B illustrate a very thin tape, total unstretched thickness, in one range, typically about 2 to 16 mil, size to fit within the wall opening of a vessel, such as an aircraft.

FIGS. 13A, 13B, 13C, 14, and 15 all illustrate a method of manufacturing a sealant in the embodiments disclosed herein.

### DETAILED DESCRIPTION OF THE ILLUSTRATED EMBODIMENTS

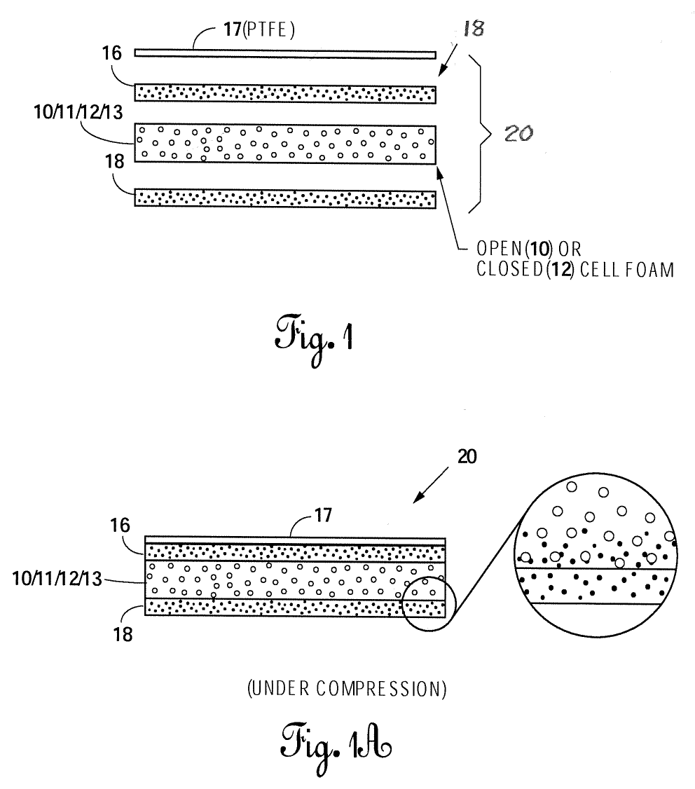

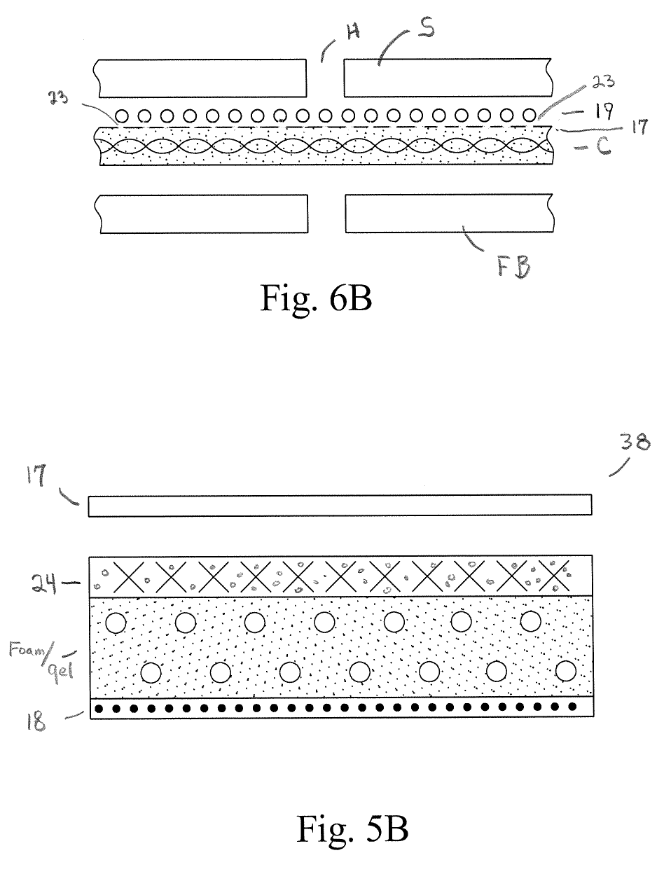

Sealants include tape and gaskets. A skin may be located such that it forms an outer layer of the sealant. A carrier generally absorbs some of/or is saturated with the polymer gel. Foam and skeletons are two types of carriers. FIG. 1 illustrates a sealant structure 20 which may be used as a gasket, tape or sealant, which may be comprised of a carrier comprised of either an open 10, semi-open 11, closed 12 or reticulated 13 foam carrier or any other suitable foam, such as, in one embodiment, polypropylene, PTFE or polyurethane foam. In one embodiment, a non-adhesive, sticky or tacky cured polyurethane gel top layer 16, and a similar bottom layer 18 is provided in a manner that may either partially or completely saturate the foam and/or adhere to the surface of the cell foam. In some embodiments, the foam based sealant will pass 25 FAR 853(a) flammability and Airbus ATTM Smoke Density and Toxicity tests. In some embodiments, a sheet or skin 17, which may be PTFE and may be, in some embodiments, fluid and moisture proof, is adhered to the top and/or bottom foam layer, so it adheres to the gel, but presents a non-sticky, slideable moisture proof surface to the workpiece or base. This provides ease of positioning the workpiece when the gasket is in place on a base. In other embodiments, skin 17 is semi-permeable or porous, such that it is dry when the gasket is not under significant compression between two parts, but the tacky gel 19 (see FIG. 6B, perforations 23) seeps through when the gasket is compressed, such that there is an environmental seal, but the resulting semi-permeable surface is not as tacky as the opposite, unskinned piece. Typically, the skinned or semi-permeable side will be against the workpiece (which is intended to be removed, see access door or floorboard, FIG. 6B) and the sticky side is to the base or stringer.

Applicant's sealants have a number of properties favorable to providing effective environmental sealing in the harsh conditions to which aircraft are subject to, as set forth herein. Among those properties is the ability to resist degradation from exposure to fluids, such as fluids that may be found in an aircraft environment, including, for example Jet A fuel and hydraulic fluids that are phosphate-ester based such as Skydrol (U.S. Application No. 62/526,248, filed Jun. 28, 2017, incorporated by reference herein).

In some embodiments, the sheet or skin 17 will not undergo elongation (that is, 10% or less, 5% or less or 0%, the elongation of the skin measured apart from the sealant and at less than elastic limit.) In some embodiments, the sealant structure itself will not undergo elongation. “Non-stretch” skin and foam embodiments may be used with any of the sealants disclosed in these specifications.

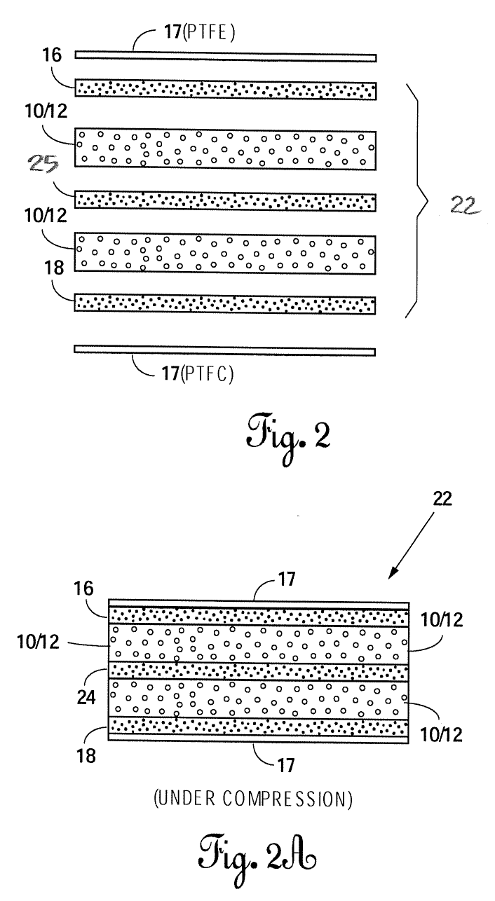

FIG. 1A and the Detail illustrates foam in a compressed state that allows at least some of the gel to soak through and into open cells of the foam. Even with closed cell foam, there is typically some migration of polyurethane gel into the foam under compression between a workpiece and a base or another workpiece. FIG. 2 illustrates another sealant structure 22, in which a pair (or more) of partly or fully gel soaked foam carriers, typically polypropylene or polyurethane foam, are used with a sticky or tacky gel middle layer 25 of cured elastomeric polyurethane gel, along with a top 16 and/or bottom gel layer 18. This additional gel may provide additional resiliency to the composition and help the foam layers to adhere to one another. Skin 17 may be provided on the outer surfaces of either of the gel layers 16/18 as in the FIG. 1 embodiment.

Foam carriers 10/11/12/13, in some embodiments, alone (no skin or skeleton) may stretch, indeed up to over 400% (with recovery, no permanent deformation). They also act as a carrier for the tacky polyurethane gel for absorption there into. Skin 17 or other suitable material may be used on either the top or bottom (or both) of the sealants as a moisture barrier and to help provide a non-tacky, slick surface for engaging a workpiece or base. In some embodiments, the skin 17 is semi-permeable, after compression of the sealant allows seepage of gel therethrough (see FIG. 6B, skin 17 with perforations 23). As such, it provides the advantages of a dry skin before it is placed under compression, but also the seepage under compression of the gel allows for the moisture prevention.

FIG. 2A represents sealant structure 22 in a compressed state, such as between an aircraft base and a removable aircraft workpiece. As in FIG. 1A, it may be seen that the foam layers or carriers may at least partially absorb some of the polyurethane gel. The use of the foam carrier may provide some resiliency to the sealant as well as some dimensional stability to the sealant. The use of more than one type of foam in a single sealant structure, such as both an open cell and a closed cell may provide additional resiliency.

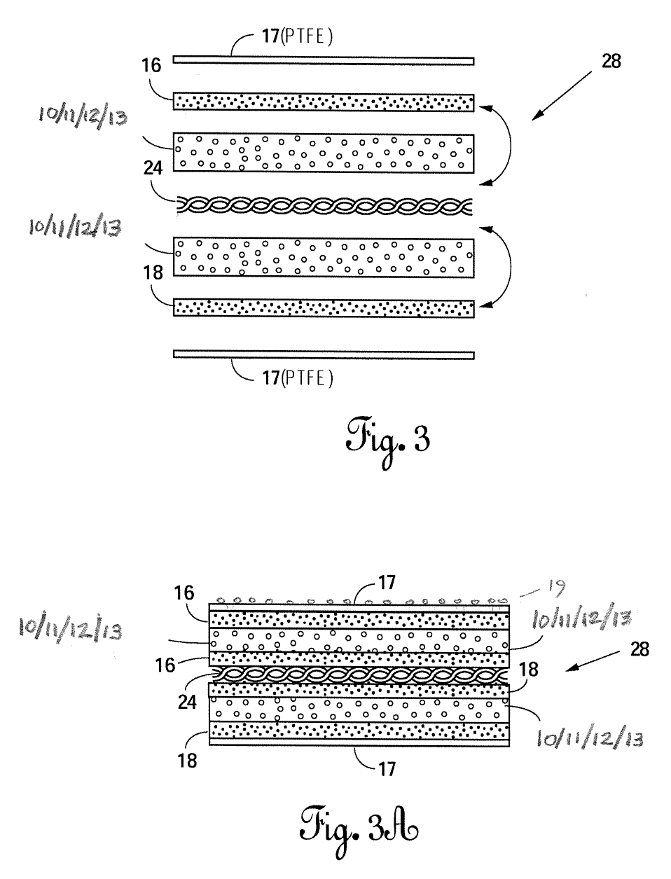

FIG. 3 illustrates a sealant structure 28 that includes a skeletal member 24, which in one embodiment is woven, such as a metallic or non-metallic fabric. On both sides of the skeletal member 24, foam carriers 10/11/12/13 at least partly saturated may be provided. In one embodiment, the skeleton is substantially non-stretchable (less than 10%, 5% or 0% elongation on the long axis apart from the sealant). In one embodiment, it is a non-stretchable fiberglass woven material. Gel layers 16/18 may be interposed between the foam or on the outside of both foam members (see FIG. 3) or both. In one embodiment, two open cell foam carriers “sandwich” polyurethane gel layers, with no polyurethane gel on the outside of surfaces of the two foam carriers. In other embodiments, polyurethane coats one or both of the outer surfaces of the foam carrier.

Another foam that may be used as a carrier is a laminated, non-stretchable open cell foam sold under the trademark HyPUR-cel T or I series. These are foams laminated with films, non-wovens or vinyls or other non-stretch fabrics (see rubberlite.com). This foam may be at least partly saturated with a tacky polymer.

FIG. 3A shows sealant structure 28 under compression wherein in the manufacturing or compression process an open cell polypropylene or other suitable foam has absorbed at least some of the polyurethane gel and the polyurethane gel has worked through the weaves of a skeletal fabric, such that the sealant structure 28 (except with impervious embodiment of skin) is saturated or substantially saturated with the gel. FIG. 3A illustrates the post-compression condition resulting from the use of a semi-permeable skin, namely, a thin gel layer 19.

Sticky, soft polyurethane gels are disclosed in U.S. Pat. Nos. 6,530,577; 6,695,320; and 7,229,516, which patents are incorporated herein by reference and US Publication 2004/0041356, which is incorporated herein by reference. Some of the sealant structures may be made according to the teachings set forth in US Publication Nos. 2004/0070156 and 2004/0041356, incorporated herein by reference.

Gaskets may be made as by die cutting as set forth in US Publication Nos. 2004/0070156 and 2004/0041356, and U.S. Pat. Nos. 6,530,577; 6,695,320; and 7,229,516. The foam may be; in one case, open, partially or closed cell polypropylene foam, in the pre-compressed thickness range of about 30 to 250 mil thick. The sealant structures formed may have a pre-compression thickness in the range of about 30 to 500 mil, and a compressed thickness of about 10 to 450 mil when under about 50 to 500 psi. The foam, in some embodiments, may pass all FAR 25.853 tests, or at least 12 sec. vertical burn.

The uses of the sealant structures illustrated may be for aircraft gaskets or sealant tape. They may be used underneath the floorboards, underneath laboratories, on stringers, sealing access panels, on antennae and in galleys to help prevent corrosion. They may be used on interior access panels. Skin 17 is shown to be, in one embodiment, a PTFE sheet acting as a moisture barrier and providing substantial dimensional stability. It may be any suitable moisture proof material that sticks to the polyurethane and contacts the workpiece. It may be used on one side, both sides or it may be omitted entirely. In some embodiments, an otherwise impermeable skin may have many small 1-10 mil diameter holes therethrough to provide some seepage of gel 19 under compression (see FIGS. 3A and 6B). Skeleton 24 may be metallic or non-metallic, may be fiberglass, may be woven or unwoven and, in one embodiment, with a weave density of approximately 20 to 80.

The polyurethane may be the polyurethane as described in the patents and publications incorporated herein by reference (see U.S. application Ser. No. 15/697,266, filed Sep. 6, 2017, incorporated by reference herein). It may be a two component cured polyurethane, which contains no silicon, and is used in a tape or gasket. Unlike pressure sensitive adhesive layers, polyurethane provides a tackiness and retentivity and provides both a good environmental seal as well as ease of removal and reuse. In some embodiments, the gel passes a fire retardant, smoke density, and toxicity tests, Part No. P-1025 and U-1024 available from KBS, Dodd City, Tex. This gel may be used with a fiberglass skeleton.

One method of making an embodiment of a foam sealant structure may be found in US Publication No. 2005/0109190 entitled Dampening Material For A Drum. This publication is incorporated herein by reference. While the reference discloses an open cell foam, a closed cell foam may be partially saturated with a pre-cured polyurethane mix as set forth in the published application and then allowed to cure. Closed cell foam may be used with the uncured mix, which will typically penetrate at least those cells of the closed cell foam that are open to the surface of the foam carrier. Moreover, when the closed cell foam is subject to compression as when a workpiece is tightened down to a base with a gasket having closed cell foam and gel coated structure therebetween, some of the cells of the foam may break and the gel, though cured, is deformable and flowable under compression and may be forced into such broken cells. Thus, even closed cell foam may have some penetration of the gel thereinto.

In an alternate embodiment of any of the sealants, sheet or skin 17 is not PTFE, but is a woven fabric, metallic or non-metallic, with sufficient open pore space to allow some of the gel to seep through under compression, typically between about 30 and 500 psi. This results in a “semi-tacky” surface and easy removal of the one piece base, but still provides for a good environmental seal against the workpiece or a base due to its ability to allow the tacky gel to seep through the material and reach the surface of the workpiece and base and fill surface irregularities and the like.

With a skin or sheet on one side, it can provide single sided sealing. With a semi-porous skin on one or either side, it can provide a semi-tacky gasket or tape sealant. One such fabric that will provide a semi-porous skin is a metallized woven fabric Zell-CR, from Shieldex Trading, Palmyra, N.Y. Another is PTFE or other impervious film with multiple holes therethrough.

Porosity or void fraction is a measure of the void (“empty”) spaces in a material, and is fraction of the volume of voice over the total volume, between zero and one, or as a percentage between 0% and 100%. Applicant provides for porosity in a skin and/or carrier in a number of ways. One way is an impervious material such as PTFE tape, which is perforated with holes to make it pervious. The second is woven fabrics which woven fibers themselves may be impervious, but the fabric as a whole, being woven, is porous. Woven materials include, for example, woven nylon. Other woven fibers may be cotton, rayon, woven PTFE or silk. The fabric may be a multifilament woven fabric or a monofilament fabric, a flat fabric may be irregular in structure (fibers randomly intertwined) or may be regular as in a woven fabric. Elastomeric fabrics may also be used. These include knitted elastomeric fabrics, for example, 88% polyester/12% spandex knit elastomeric fabric and an electrospun elastomeric polyurethane non-woven fabric. The fabric may be single or multi-layer woven or more and the fabric may be coated or uncoated to alter its initial porosity. Some skin and/or carrier fabric is fire retardant and passes one or more of FAR 25.853 and Airbus AITM tests for: smoke density, smoke toxicity and flammability.

Permeability is the ability of a fabric or other material to permit a substance to pass through it. Quantitatively, it is the amount of substance which passes through the material under given conditions. For example, standard parachute fabric air permeability testing is carried out a pressure difference of 0.5 inches of water (about 150 Pa). Permeability and porosity are strongly related to each other. If a fabric has a high porosity, it can be assumed that it is permeable. The fabric with zero porosity can be assumed to have zero permeability.

Air permeability is an important factor in determining the performance of the skin or carrier materials set forth herein as it can help provide a guide to permeability of a fabric with respect to a polyurethane or other polymer gel across the skin based on the assumption that a higher air permeability would provide for a higher gel permeability. ASTM D 737 is a standard test measurement of air permeability of textile fabrics.

Fabrics that may be used as skin and/or carriers include: woven fabrics, non-woven fabrics, air bag fabrics, napped fabrics, knitted fabrics, layered fabrics and pile fabrics. The fabrics may be untreated, coated, resin treated or otherwise treated. Fabrics may be calendared to reduce air permeability. In the standard ASTM D 737 test method for air permeability, air flow passes perpendicular through a known area of fabric and is adjusted to obtain the prescribed air pressure differential between the two fabric surfaces. From this rate of air flow, air permeability of the fabric is determined.

Air permeability values may be expressed in cubic centimeters/s/cm2 and in feet3/minute/foot2. Permeability of fabrics, including woven fabrics in some embodiments may be between about 4 and 400 and in some embodiments, between about 45 and 300. Air permeability of some fabrics, including non-woven fabrics may be between 9 and 1400, in some embodiments, between 100 and 900. All the foregoing units ft3/minutes/ft2. In some embodiments, the skin is nylon parachute cloth 1.2-1.8 oz/ft2. In some embodiments, the thickness of the skin is between about 1 and 4 mil and air permeability is between about 10-50 cm3/cm2 sec.

Among the skins, carriers or directionally stable layers that may be used with Applicant's tapes or gaskets disclosed herein are porous plastic, including without limit, porous polyethylene, polypropylene, PVDF, PTFE, ethyl vinyl acetate, and other porous plastics. One microporous PTFE sheet is Porex® Microporous PTFE available from Porex Filtration Group (Fairburn, Ga.) (see Porex.com.) Also, expanded PTFE, also known as ePTFE may be used. Another material that may be used as a stretchable skin or carrier, is porous sponge PTFE that is compressible and has great recovery characteristics. Its absorbency and porosity may be increased by multiple pinpricks or perforations in the surface thereof to allow the absorption and/or passage of a gel therethrough. Indeed, any porous sponge polymer may be used for a skin, carrier, sheet or dimensionally stable layer. Other products are microporous PTFE ZITEX G. While ZITEX G may be used without perforations or pinpricks, it may also be used with pinpricks or other perforations to allow the passage of gel therethrough.

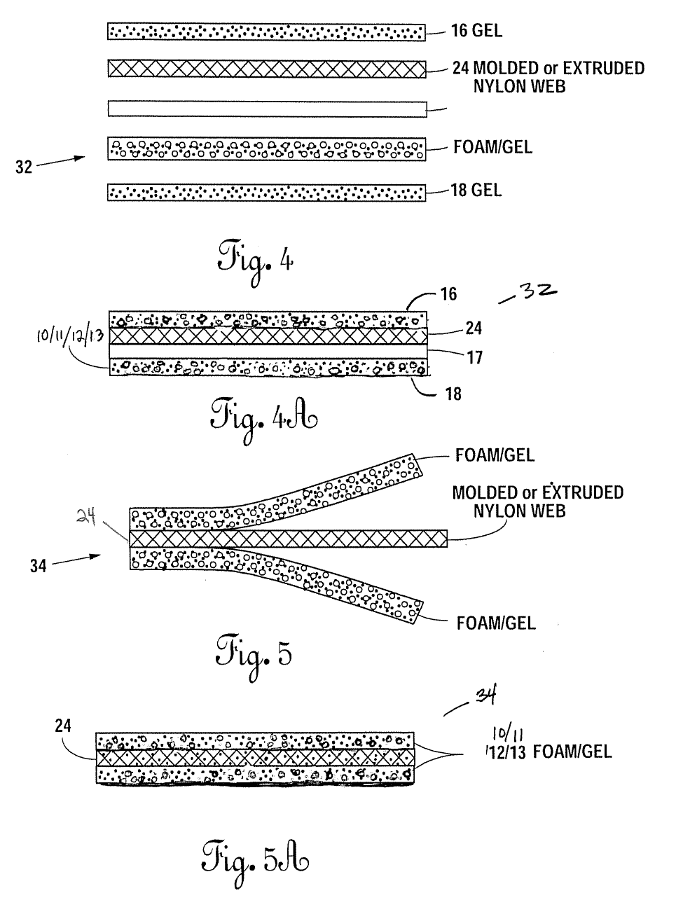

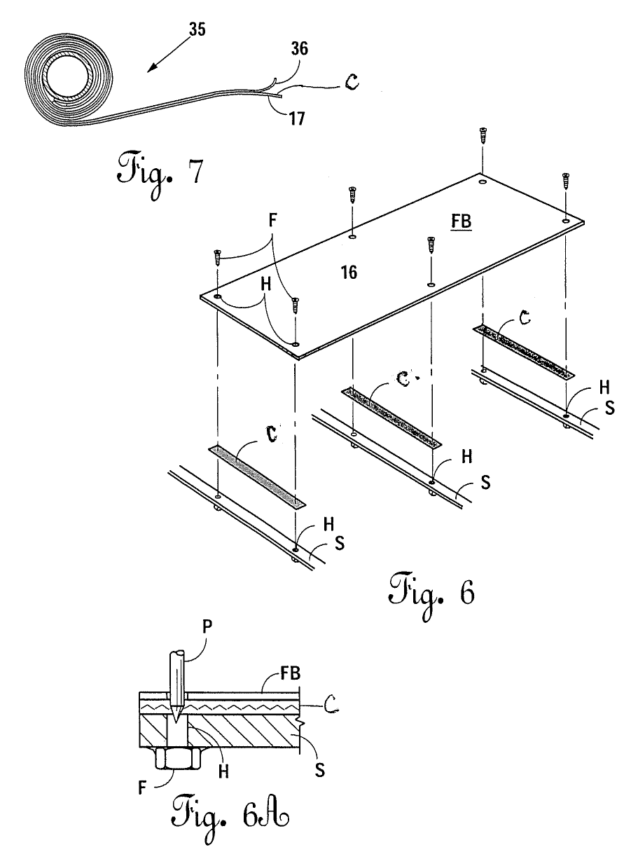

FIGS. 4, 4A, 5, 5A, and 5B illustrate alternate preferred embodiments of Applicant's sealant embodiments. FIGS. 4 exploded and 4A under compression illustrate the use of a specific type of carrier, a skeleton 24, more specifically, a molded or extruded nylon web or any of the other skeletons disclosed in U.S. Pat. No. 14/484,570, filed Sep. 12, 2014, incorporated herein by reference. While Applicant is illustrating in FIGS. 4, 4A, 5, 5A, and 5B, the use of the specific skeleton in the form of web 24, it is to be understood that any of the other embodiments of the invention or sealant structures set forth herein may have this skeleton, for example, the embodiments illustrated in FIGS. 3 and 3A. Indeed, the skeletons of any embodiment may be metallic, non-metallic, woven, non-woven, rigid metal foam, molded or extruded nylon or plastic, web or any other material that is comprised of a non-foam material that will provide, in some embodiments, dimensional stability including, in some embodiments, substantially no elongation apart from the sealant, and structural integrity to the foam/gel and other elements of the sealants while being capable of retaining, in voids or openings therein, a gel or other suitable tacky, non-adhesive matrix.

In FIGS. 4 and 4A, a tacky sealant structure 32 is illustrated. The skeletal web typically carries a thin top layer 16 of gel on the upper surface thereof, and gel therethrough in the voids of the skeleton 24 and, if a skin is used (as shown but optional), then stickiness on the lower or bottom surface of the gasket may be provided by foam 10/11/12/13, which may comprise an at least partly open cell foam, which may be partially or fully saturated with gel or other suitable tacky matrix. Typically, at least a thin, sticky lower layer of gel 18 is present on the finished sealant 32.

As stated above, the foam may be any flexible, compressible foam of an opened, closed or semi-opened cell foam, including a semi-opened cell nylon foam. Any of the sealants disclosed may have skin or sheet 17 on the upper, lower or both surfaces or in between the outer surface of the sealant structure. Using the skin, of which impermeable PTFE is one example thereof, may present a substantially non-tacky surface to the workpiece. In some applications, it may be preferable for the sealant to have a tacky side, with a tacky gel on the surface of a foam or on the surface of a skeleton, such as seen in FIG. 4, for exposure to and contact with the workpiece under compression to provide a good environmental seal. Using a porous skin, or semi-permeable skin (see FIG. 6B, with perforations 23) will allow for a skin being dry or moist in an uncompressed condition, to become sticky when under compression.

Other types of foam are those disclosed in Application US 2013/0224434, incorporated by reference herein, which disclose using an open cell foam with pressure sensitive adhesives other than a gel for stickiness. Applicant's embodiments of these foams would use the gel instead of the PSA.

Applicant's gel may be a polyurea, polyurethane gel or other suitable two-part polymer. It may have a peel strength of about 0.3 and 1.0 lb./in. width, or between about 0.1 and 2.0 lb./in. width. Gel soaked open cell foam with a PTFE liner (AVDEC HT-3000) and another with a 2 mil polyfilm (AVDEC AD-89513) yields a range of 65-85 Shore “00” or 35 to 65 Shore “A”. This range is appropriate for Applicant's sealants, also a broader range 50-100 on Shore “00”, 25-75 on Shore “A” may be used. The gel can be two-part mix chemically cured as seen, for example, in U.S. Pat. No. 7,229,516, incorporated herein by reference, or may be thermally or otherwise cured. The gel is typically impregnated into the foam in those sealants which call for such partial/complete saturation, and the gel is uncured when the gel is allowed to cure in place in and on the foam.

In some embodiments, the gel may be infused with or carry in suspension conductive particles for providing some conductivity between workpieces, such as metal parts, providing compression to Applicant's sealants. These particles may be graphene mixed in the gel or the resin and graphene mix as disclosed in U.S. Pat. No. 8,652,362, incorporated herein by reference. The sealant of claim 21, wherein at least some of the particles are graphene; wherein at least some of the particles are metal and coated with a metal oxide which is derived from a trivalent chromium compound and a hexafluorozirconate; and wherein at least some of the particles are metal particles and comprise one or more of aluminum, nickel, zinc, silver, gold, magnesium, copper, iron. The metal pigments disclosed in US Publication No. 2013/0168612, incorporated herein by reference, the particles, including the metal particles, disclosed in the Parker-Hannifin U.S. Pat. No. 8,633,402, incorporated herein by reference, or any other suitable conductive or semi-conductive particle. Conductive or semi-conductive particles may be especially useful in EMI applications.

Both gaskets and tape are anticipated for the configurations of Applicant's sealants disclosed herein. Some of these sealants, that lack a skeleton or have a skeleton that is stretchable may be suitable for a partially stretchable tape that may be used to wrap electrical conductors as found, for example, in U.S. Pat. No. 7,229,516, incorporated herein by reference (see FIG. 18). All sealants can be with or without a skeletal member and with or without a moisture proof skin or semi-permeable.

FIGS. 5 and 5A illustrate another alternate preferred sealant 34, which comprises Applicant's novel molded or extruded nylon or plastic web 24 as seen in the '570 application, with a foam/gel on the top and the bottom thereof. A carrier comprising foam 10/11/12/13 may be open, closed, reticulated or semi-opened, and may be partly or fully saturated with the gel to provide tackiness on either or both sides of the sealant structure 34.

FIGS. 5 and 5A illustrate embodiment of a sealant structure 34 with a foam gel layer 10/11/12/13, which may be manufactured according to the AVDEC patents incorporated by reference. Also, a nylon web or skeleton 24 is placed adjacent a surface of the saturated foam gel before the material is compressed between two parts. The foam carriers 10/11/12/13 are positioned above and/or below the skeleton and contact the aircraft part. The nylon web may be partially or fully saturated before placement adjacent the foam gel, before placement between the aircraft parts or the nylon web may be dry and compression when the aircraft parts are torqued down will force the gel from the foam gel to migrate into the open spaces of the nylon web and adjacent the face of the workpiece adjacent the nylon web, effectively coating it to provide environmental seal.

FIG. 5B illustrates another embodiment for Applicant's sealant structure 38, which may be between floorboards FB of an aircraft and support stringers S or members (see FIG. 6). In this particular embodiment (FIG. 5B), sealant 38 is a “skinned” version of Applicant's tacky sealant structure 34 and may be used with the tacky side on the aircraft structure and the impermeable or partially porous skin 17 against the surface of the floorboard for ease of positioning the floorboard and ease of removability.

FIGS. 6, 6A, and 6B illustrate the use of any of Applicant's sealants herein designated “C” in a particular embodiment, namely, between the floorboards FB and stringers S of an aircraft. Typically, stringers S have multiple holes H therein and floorboards FB are fastened down to the stringers S with a gasket or tape material therebetween to help avoid corrosion and the spread of moisture. In one embodiment, a tape 35 comprising a linear strip of sealant C is provided, which tape 35 may include release film 36 (see FIG. 7) on a surface thereof and may, in one embodiment, be a sealant C with a skin on an upper surface thereof. That is, sealant C may be placed, sticky side down, onto stringers S and skin 17 on an upper side of the sealant will allow easy movement of floorboard FB to align holes H in the floorboards with holes H in the stringers and the application of fasteners F therethrough. A piercing member P may be used after the floorboards are in place to pierce through sealant C to allow fasteners F to pass therethrough following removal of piercing member P. Skin 17 may be impermeable or semi-permeable. In FIG. 6B, a structural sealant is illustrated for use between floorboards and stringer that has no foam, but a fire retardant gel encapsulated stretchable or non-stretchable skeleton, in some embodiments, a fire resistant fiberglass. Sealant C is fully tacky when ready to use on the unskinned side and dry on the semi-permeable side. Under compression, when the floorboard fasteners are torqued down, seepage 19 will result.

Ease of removability may be achieved by using a skeleton of a harder nature, for example, Applicant's molded or extruded nylon skeleton instead of woven fiberglass or a non-woven skeleton is more resistant to compression. Ease of removability may also be achieved by using a thicker skeleton, for example, a skeleton in the range of 18 to 28 mil, rather than, for example, in the range of 8 to 17 mil. The foam under compression may tend to impeded somewhat the lateral movement of gel with less edge squeeze out than cured gel.

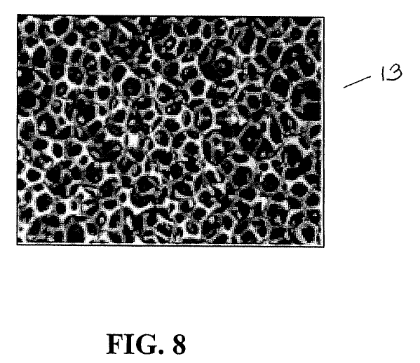

FIG. 8 illustrates a reticulated flexible foam for use in any of Applicant's tacky sealants. Reticulated foam is a very porous, low density, solid foam. “Reticulated” means like a net. Reticulated foams are extremely open foams and few, if any, contain cell windows. A reticulated foam may be made of an organic binder, like polyurethane, and be flexible. They have a high porosity and a large surface area. Porosity may be over 90%, sometimes 95%, or as high as 98%. Reticulated foams are sometimes used in scrubbers or air conditioner filters. Any of Applicant's embodiments may use reticulated foam carrier 13 and, in one case, a reticulated foam provided by Riley Foam Corporation as the SIF® filter foam for air filter applications. In some embodiments, this is a polyester urethane foam with a three-dimensional structure of skeletal strands. Each cell in the foam is completely interconnected with all surrounding cells. It has a high tensile strength and tear resistance together with easy workability. This filter foam is produced in a number of pore sizes, expressed as the average number of pores per linear inch, and may run from about 5 to about 100 ppi. It can withstand intermittent temperatures as high as about 250° F. and has a void volume of about 97%. It is not adversely affected by water, detergents or else solvents or grease at normal operating temperatures. Tensile strength ranges between about 22 to about 35 psi, and elongation between about 275% to about 400%. Nominal pore size may be variable for a given thickness and, in one embodiment, may be between 40 and 110 and a porosity grade between 45 and 100.

FIGS. 1, 2, 3, and 4 show gel layers separate from the foam for illustration, but it is to be understood that unless the foam is a closed cell foam, the open, semi-open or reticulated foam is at least partly saturated prior to use by the methods set forth in the AVDEC patents. When semi-open or open cell foam is used, the gel may be layered separately, alternating with the closed cell foam in the methods described in the patents.

When non-closed cell foams are used in the manufacturing process as set forth in the patents that are incorporated by reference, it is to be understand that in all of the compositions, gel tends to migrate when the compositions are placed (when an impervious skin is used) between workpieces which are then placed under compression, for example, by fasteners. The gel will tend to migrate between openings in any type of a skeletal member, openings in the open cells of the foam, including closed cell foam where the cells have been broken by virtue of compression, and typically vertical migration stopped only by impervious skin/barrier. That is to say, the sealants, excepting the skin (when an impervious skin is used), are typically encapsulated with gel, the gel providing a good environmental seal, the foam providing some resiliency and some (though usually not total) resistance to migration as well as some structural stability and the skeleton, if present, providing additional stability including, in some embodiments, in elongation.

In some embodiments, the sealants comprise tapes having a skeletal or foam carrier that is at least partially open cell. One such foam is selected to pass Airbus AITM smoke Density and Toxicity and/or FAR 25,853 interior flammability tests (or at least 12 sec. vertical burn). Such a foam tape may be at least partially saturated with any tacky, polyurethane or polyurea gel, including those found in U.S. application Ser. No. 15/697,266 filed Sep. 6, 2017 and U.S. Pat. Nos. 7,229,516; 6,695,320; and 6,530,577. This carrier and gel combination can be used with any skin 17, whether PTFE or any other non-stretchable, moisture proof or semi-permeable sheet or skin, at any of the positions with respect to the carriers shown herein. In addition, this foam and gel combination, with or without sheet 17, may be used with any of the skeletons disclosed herein, including skeletons that do not stretch. Such a combination, in some embodiments, will yield a tape sealant that is substantially non-stretchable, but is compressible and tacky (on at least one surface) providing a good environmental seal and will cleanly release from an aluminum or aluminum alloy surface. In some embodiments, the sealant is stretchable less than about 10% (has linear dimensional stability, in another less than 5%, and in another 0%) while still being compressible in the short axis (thickness). These percentage ranges are at forces below the elastic limit of the material. The foam, in some embodiments, resists compression set and is resistant to ultraviolet light (SAE J-1960), ozone (ASTM D 1171, no cracks), retains its properties over extreme temperatures (about −67° to 392° F.) and is flame/fire resistant (meets FAR 25.853(c) aircraft interiors). Its elongation in a dry configuration is typically about 90% (ASTM D 412), but when combined with Applicant's sheet 17 and/or skeleton, elongation may be reduced to less than 10%, in some embodiments less than 5%, and some embodiments 0%. Other flammability properties include flame resistance (UL 94 listed V-0 and HF-1), flame spread index (less than 35 ASTM E 162), smoke density (ASTM E 662 less than 50 tested at 4 min, less than 20 tested at 1.5 min) and toxic gas emissions (passes SMP-800C and BSS 7239).

Applicant provides any suitable foam with a gel that results in a non-adhesive sealant, that does not bond to (such as would a pressure sensitive adhesive), but instead is releasably tacky to the aircraft base and workpiece (typically aluminum alloy) to which it is placed under compression. One measure of this non-adhesive tackiness is the foot retraction test as set forth herein.

Scope

This establishes a test method for evaluating the tack of gasket products, made with a polyurethane or polyurea or other polymer gel.

### REFERENCES

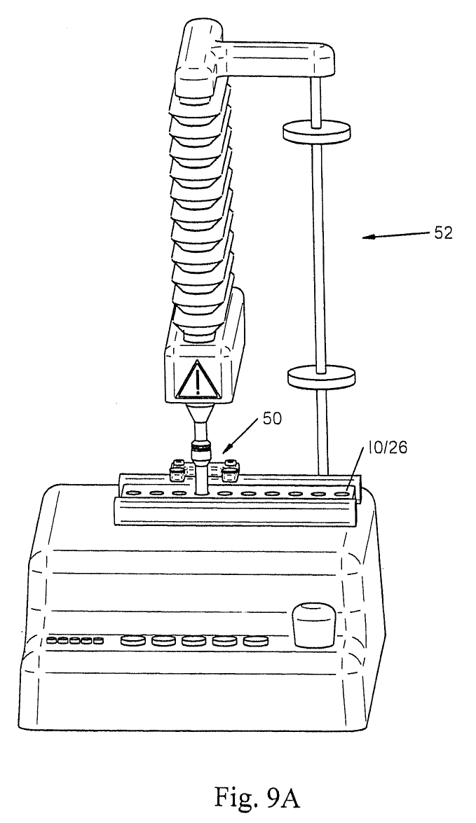

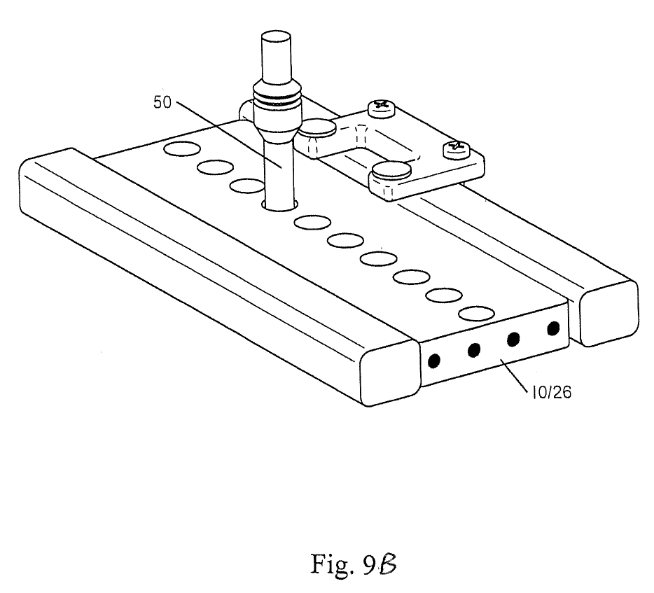

Test Assembly (see FIG. 9A)

The test assembly consists of a test specimen only. The test specimen is a 1″×6″ sample of a polyurethane gel. The test specimen shall be tested at a temperature of 73.4±3.6° F. Texture Analyzer—a machine that measures force compared to deflection is used, Texture Technologies TA.XTPlus with a 50 kg load cell. See FIG. 9A for typical machine setup. For calibration weight—a precision mass used for calibrating the load cell.

Open the Exponent program, select a user, and click OK. Three calibrations should be done before testing—height, force, and frame stiffness. To calibrate height, clear the texture analyzer of any testing materials. Click T.A.>Calibrate>Calibrate Height, enter the following values: Return Distance—10, Return Speed—10, Contact Force—1000, and then click OK.

To calibrate force, clear the texture analyzer and the calibration platform of any testing materials. Click T.A.>Calibrate>Calibrate Force>Next, enter the weight of the calibration weight to be used, place the calibration weight on the calibration platform, click Next, remove the calibration weight, and click Finish.

To calibrate frame stiffness, clear the texture analyzer of any testing materials and ensure the proper load cell is installed. Click T.A.>Calibrate>Calibrate Frame Stiffness, enter Max Force—90% of the load cell capacity and Speed—0.01, click OK, and click OK again.

Testing Procedure. To open the project, click File>Project>Tack. Click the test configuration button and enter the name of the test in the Input File ID box, typically with the following format: Name of material—thick/thin side-Person who shot the material—Front, Middle, End section of the table—(for example, HTB-TN-SW-EN-). Enter the batch information in the Batch box typically with the following format: #Lot Number-Carrier Lot Number (for example, #5037-M1517B). Ensure that the AutoSave is checked and the file path is correct so that it will save to the proper folder (see FIG. 9A for typical test configuration). Remove release film on side of sample to be tested and apply the sample to the test specimen panel. Slide the test specimen panel into the base unit and tighten down in the spot to be tested. Clean the probe tip with a paper towel moistened with Isopropyl Alcohol. To begin the test click run Macro>Yes.

Among the applications to which or assemblies with which Applicant's sealants may be used are aircraft access panels, including exterior or interior access panels, for example, an access panel on Airbus A320, which provides access to the forward landing gear.

Test 5

This establishes Applicant's standard test method for evaluating the tack, work of adhesion and cohesion of polyurethane gel sealant products.

Test Assembly

This test assembly (see FIGS. 9A and 9B) consists of a test specimen 26. The test specimen is typically a 1″×6″ sample of a polyurethane gel sealant material, here, S.D. #5. The test specimen is tested at a temperature of 73.4±3.6° F.

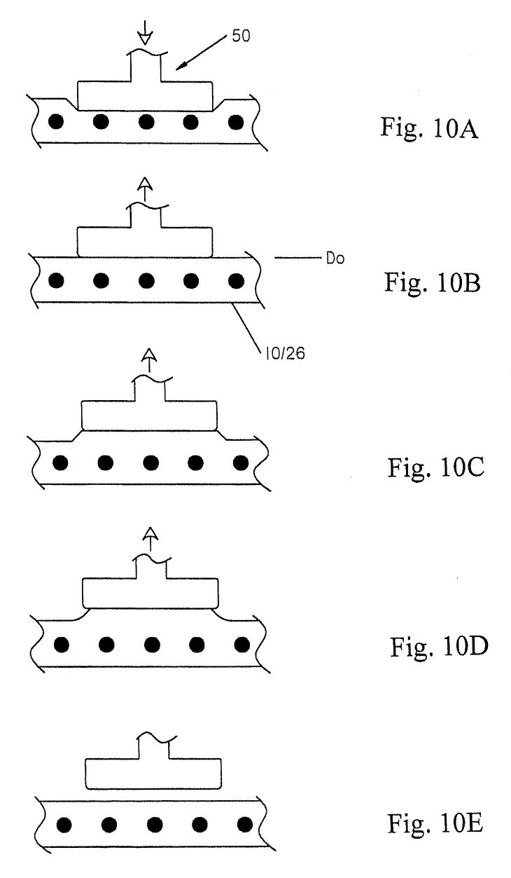

Texture Analyzer is a machine 52 that measures a number of variables, including tack, work of adhesion and cohesion of the sealant surface, when a probe moves upward from a downward deflected surface position, caused by probe 50. Applicant uses a Texture Technologies TA.XT plus with a 50 kg load cell (Texture Technologies, Hamilton, Mass., see texturetechnologies.com). See FIGS. 10A and 10C for Applicant's typical machine setup. The calibration weight is a precision mass of 200 gr. used for calibrating the load cell.

Procedure

Open the Exponent program, select a user, and click OK.

Calibration Procedure: Three calibrations shall be done before testing—height, force, and frame stiffness.

Height: To calibrate height, clear the texture analyzer of any testing materials. Click T.A.>Calibrate>Calibrate Height, enter the following values: Return Distance—10, Return Speed—10, Contract Force—1000, and then click OK.

Force: To calibrate force, clear the texture analyzer and the calibration platform of any testing materials. Click T.A.>Calibrate>Calibrate Force>Next, enter the weight of the calibration weight to be used, place the calibration weight on the calibration platform, click Next, remove the calibration weight, and flick Finish.

Frame Stiffness: To calibrate frame stiffness, clear the texture of any testing materials and ensure the proper load cell is installed. Click T.A.>Calibrate>Calibrate Frame Stiffness, enter Max Force—90% of the load cell capacity and Speed—0.01, click OK, and click OK again.

Testing Procedure: To open the project, click File>Project>Tack. Click the test configuration button and enter the name of the test in the Input File ID box, typically with the following format: Name of material—thick/thin side—Person who show the material—Front, Middle, End section of the table (for example, HTB-TN-SW-EN-). Enter the batch information in the Batch box typically with the following format: #Lot Number-Carrier Lot Number (for example, #5037-M1517B). Ensure that the AutoSave is checked and the file path is correct so that it will save to the proper folder (see FIG. 10B for typical test configuration). Remove release film on side of sample to be tested and apply the sample to the test specimen panel. Slide the test specimen panel into the base unit and tighten down in the spot to be tested. Clean the probe tip with a paper towel moistened with isopropyl alcohol. To begin the test, click Run Macro>Yes.

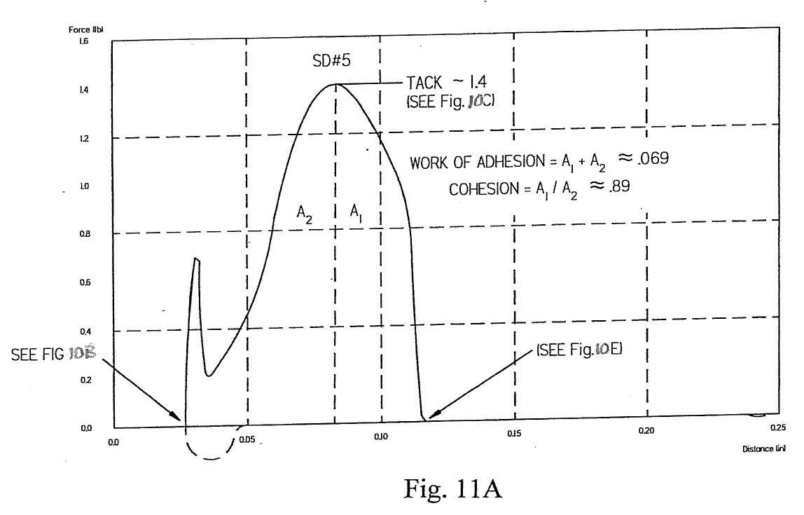

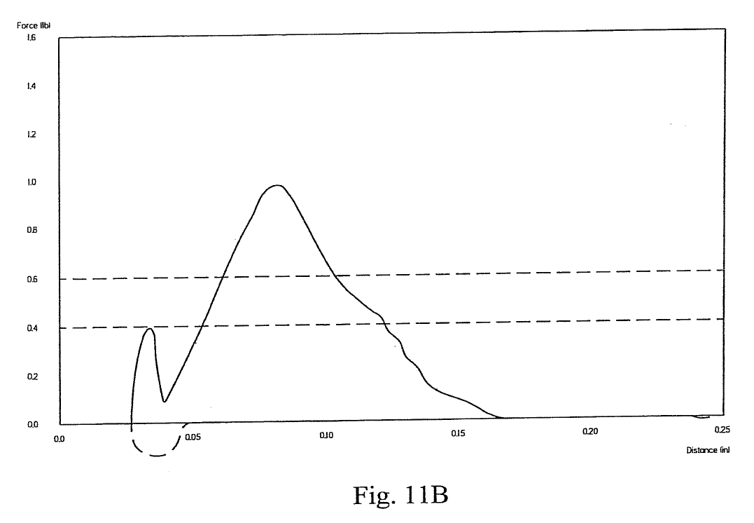

The test shown in FIGS. 9 Series, 10 Series, and 11 Series is for measurement of: tack, work of adhesion and cohesiveness. Force is measured as the probe goes up from the initial position (FIG. 10C). The foot of the probe (silver coated stainless, area ˜0.06 sq. in.) is pressed into the material (FIG. 10A) a certain distance at a certain speed and then retracted at that same speed. The force is measured on the upward retraction stroke only (FIGS. 10B-10E) to measure the “tack” of the material. Tack is the maximum point on the force vs displacement curve, the peak value. It measures the maximum amount of force needed (or psi when foot area is taken into consideration) to separate the probe from the material. The work of adhesion is the total area under the curve of FIG. 11A (above the X axis). This property should have units of lb-in (force*distance). It measures the total amount of work done (energy expended) by the retracting force involved in separating the probe from the material (FIG. 10E).

Cohesiveness is the tendency of the material to stick together. For example: taffy is more cohesive than bread. The cohesiveness is measured as the ratio of the area of the right half A₂ of the curve of FIG. 11A to that of the left half A₁ of the curve with the maximum force point (tack) defining the boundary. If adhesion is low compared with cohesion then the probe is likely to pull off the specimen easily and to remain clean as the product has the ability to hold together. If adhesion is high, out of the maximum range, then sealant is in the range of adhesives.

A graph of the tack test for the fireworthy products subject to Tests 1-5 (Applicant's sealant SD#5) and another polyurethane gel and fiberglass skeleton coated with fire retardant (without fireworthiness) designated HT3935-7 similarly dimensioned (FIG. 11B) for reference.

| | | | WORK OF | |
|---|---|---|---|---|
| | | TACK | ADHESION | COHESIVENESS |
| A. | SD.#5 (HT 2231) (FR | .91 | 0.051 | 1.188 |
| | S.D/Toxicity) | | | |
| B. | HT 3935-7 (Non-FR) | 1.378 | .069 | 0.89 |
| C. | HT 3935-7 (just FR) | 1.994 | 0.106 | 0.800 |
| D. | Foam Tape (non-FR) | 0.874 | 0.073 | 0.996 |
| | (stretch) AD89503 | | | |
| E. | Foam Tape (FR)¹ | 1.200 | 0.110 | 0.900 |

A. AvDEC White gel (KBS part U1024 and P1025), nylon skeleton carrier, no skin Approximate values
B. AvDEC Plum gel, fiberglass skeleton carrier, skin (tested on tacky side)
C. AvDEC Amber gel (KBS part U1016FR and P1017FR), fiberglass skeleton carrier, skin (tested on tacky side)
D. AvDEC Plum gel, open cell foam (non-FR), saturated, gel on both sides
E. AvDEC Amber gel (KBS part U1016FR and P1017FR), open cell foam (FR), saturated, gel on both sides, stretch seal

Following this test method will result in a graph that will record the following—Tack (lb/in²); Work of Adhesion; Cohesiveness.

Acceptable ranges:
Tack: 20-30 psi (most preferred), 15-45 psi, 5-50 psi
Work of Adhesion: 0.02-2, 0.01-10
Cohesiveness: 0.25-1, 0.1-3, 0.1-5

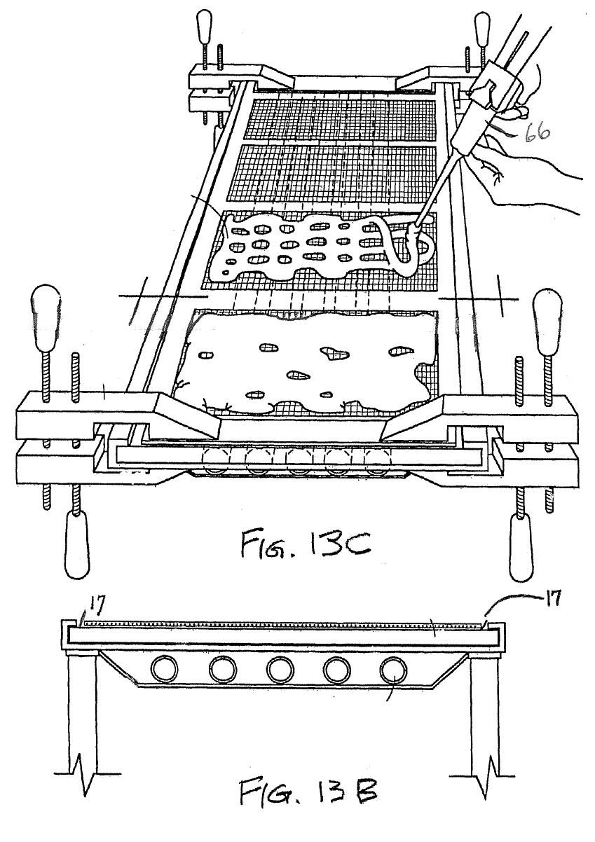

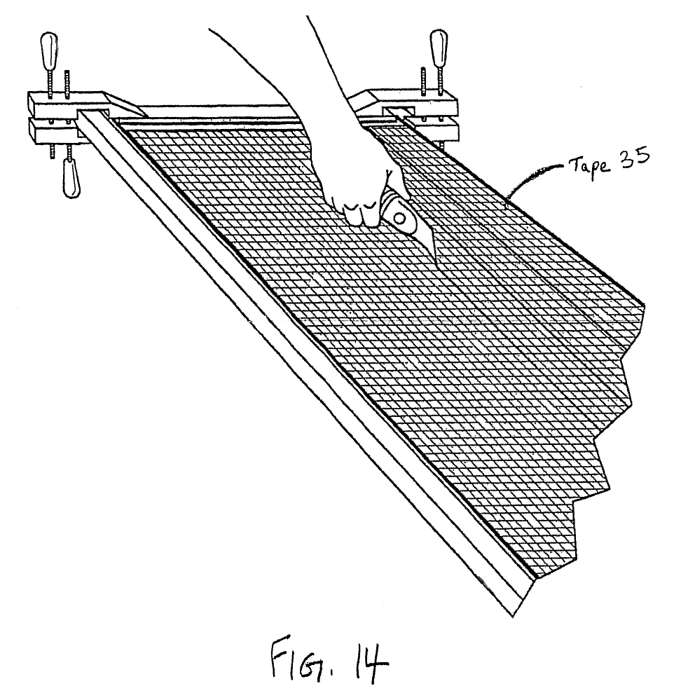

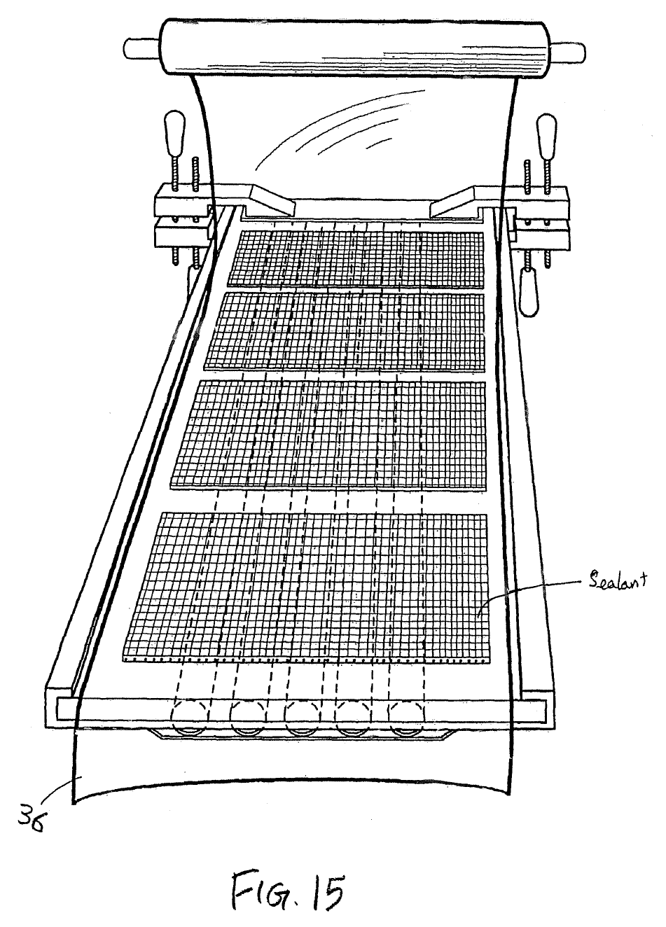

The attached FIGS. 13A, 13B, 13C, 14, and 15 show two ways of making a tape for use as indicated herein. The skin 17 of the tape can either be placed on the flattop table first (FIG. 13A), after which the carrier (for example, foam or skeleton) is placed and after which it is soaked with a pre-cured gel. In another embodiment, a release film may be placed on the tabletop, the skeleton or carrier placed on top of the release film, then the applicator 66 may be used to apply the pre-cured gel. Before or after the pre-cured gel cures, the skin 17 may be laid atop it (FIG. 15) and flattened out, for example, with a squeegee. It may then be cut into strips (see FIG. 14) to make tape.

Upper surface of skin 17 can be dry or moist with gel when ready for installation. Skin 17 is typically placed on the cured or uncured polymer gel prior to use between the stringers and the floorboard. Some porous or semi-permeable skin materials that allow a gel to penetrate are: ripstop nylon (parachute fabric); conventional weave fabrics that are highly hydrophobic and flame resistant; perforated PTFE: porous PTFE; water soluble paper, such as rice paper; other uncoated nylon fabrics that are not woven and not in a ripstop pattern; or porous fabric of any pattern, weave or material. Even ground PTFE powder or granules or other non-soluble fire retardant, preferably hydrophobic powder or granules, may be sprinkled on cured or uncured polymer prior to installation and act functionally as a “skin”. Under compression, they will become encapsulated by the gel and provide a good environmental seal.

A method of installation, with fasteners, of a floorboard on floorboard support stringers is disclosed. The floorboard and stringers have spaced apart fastener holes in and an alignable fastener spacing pattern. The method comprises the steps of: providing an elastomeric, deformable, substantially non-stretchable tape having a tacky, polyurethane gel body and a carrier, the carrier having a top and bottom surface, the carrier at least partially saturated with or encapsulated with the gel of the gel body and having some gel on the top and bottom surface thereof, and a skin, the skin being at least semi-porous to the gel when the tape is under compression, the skin on a top of the carrier, a top surface of the skin being dry or moist when the tape is in an uncompressed condition, the bottom surface of the skin in contact with the gel and adjacent the top surface of the carrier. The gel covered bottom surface of the carrier forms the bottom of the tape for contacting a stringer when the tape is ready for installation. The tape is cut to a floorboard edge length, the floorboard edge length spanning at least one fastener hole. The cut tape is aligned with a stringer having at least one fastener hole. The cut tape is placed, without stretching it, bottom (sticky side) down on the stringer. The floorboard is placed on top of the tape. The hole in the floorboard is aligned with the hole in the stringer. A hole is punched through the skin of the tape at the aligned holes. A fastener is inserted through the aligned holes and the punched tape. The tape is compressed by tightening the fasteners. Some seepage of the gel through the skin of the tape will occur such that the gel contacts the underside of the floorboard and provides an environmental seal.

In installation, in some embodiments, the tacky side is down and the dry or moist skin side is up towards the floorboard. Even when the skin is slightly moist prior to installation, it is easy to slide the floorboards around to get alignment between holes in the floorboard and holes in the stringer. While sometimes a punch may be used, in some applications, a fastener with a slightly tapered tip may be pushed through the skin layer without using a punch, to avoid possibly damaging the paint on the structure. After compression, for example, after at least about 60 minutes under about 300 psi compression (or 30-500 psi), there may be visible gel at edges and on the top surface of the skin. Even with the visible gel and after days, weeks or months under compression, the floorboard will remove cleanly from the skin side without pulling off the unskinned tape from the stringer.

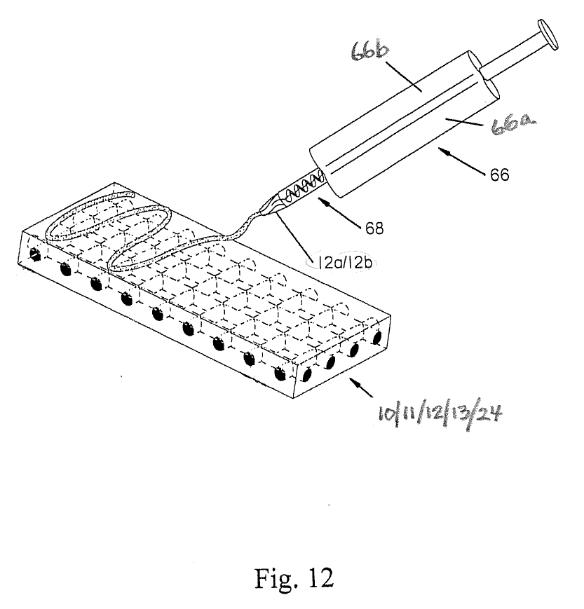

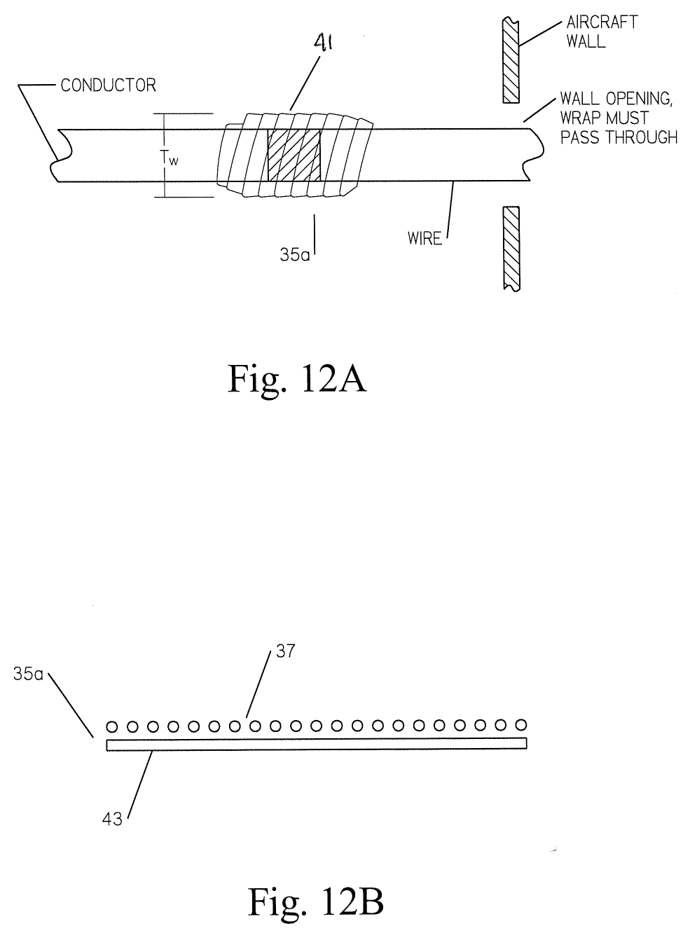

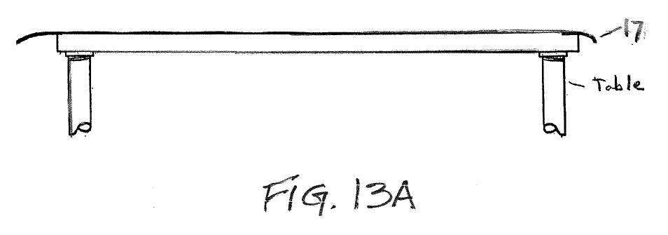

FIG. 12 illustrates a sealant comprising any carrier 10/11/12/13/24 formed by applying a two-part chemically cured sealant, such as those disclosed herein, with an applicator 66a and 66b for each part, a forcing element 66 having compartments, and a nozzle 68. Pressure on the forcing element will allow the two-part to exit in the nozzle and be deposited on the carrier. They will cure to form a tacky, non-adhesive gel, in 15 to 45 minutes. FIG. 12 also illustrates a sealant for use with floorboards, such as floorboards or floorboard access panels on an Airbus A320 or A330 aircraft. In the past, dry adhesives have been used. The tape may be non-stretchable, flat with gel on the bottom and/or top, made of a carrier as disclosed herein, in some embodiments foam, woven, molded or extruded. In some embodiments, the tape may be skinned (including a semi-porous skin) on one side or the other or neither side. Applicant's tape is typically flat. The tape should not have a pressure sensitive adhesive, but be comprised of a tacky gel, such as that set forth herein, that allows for easy removability. A pressure sensitive adhesive creates a rigid permanent bond, but is poor for maintenance, corrosion prevention, and removability.

FIGS. 12A and 12B illustrate a very thin sealant tape 35a, total unstretched and uncompressed thickness typically about 2 to 16 mil or, in another range, 2 to 10 mil, in yet another range 2 to 8 mil, sized to pass through a wall opening of a vessel, such as an aircraft. Wire conductors may have connectors or places that need to be or ought to be wrapped to provide, among other benefits, environmental seals. However, when the connectors are wrapped, it adds thickness and the already thin tolerances where the connectors must pass through a wall, floor or ceiling can provide problems. To overcome these problems and other problems, very thin sealant tape 35a may be provided which, in one embodiment, consists of a porous or impervious PTFE carrier 43, such as those described herein which, in some embodiments, is PTFE and, in some embodiments, has stretch, for example, up to 400% or less. In some embodiments, PTFE carrier 43 is ZITEX G. On the carrier is applied, to one or both sides, a thin (in some embodiments, 1 to 6 mil) polyurethane gel or other cured, non-adhesive layer 37 or other tacky gel or other tacky sealant. The joint or connector section may be wrapped, in one or more courses of thickness, with a gel layer to the conductor. In some embodiments, the total thickness of the wrap Tw is less than 16 mil. Typically, wrap 41 has at least two plies in thickness and is stretched while wrapping the conductor, and is wrapped with a single-side facing the inside to tack to either the conductor or the lower ply. This forms a good, thin, moisture-proof seal.

One semi-permeable, stretchable tape that may be used is a microporous PTFE carrier sold under the trademark Zitex G® 04 (from Saint Gobain, see saint-gobain.com.) (see FIGS. 12A and 12B). This microporous PTFE is chemically inert and thermally stable, it is breathable (air permeable), but does not allow liquids to pass through. It has pore sizes in the approximate range of 1 to 6 microns and is between 4 and 15 mil thick (uncompressed and unstretched). It is hydrophobic while allowing the free passage of gases therethrough. Zitex G® also has a high wet strength and does not contaminate metals or non-metals. PTFE may be used, in some embodiments, as a ski or a sealant with a carrier with a series of small perforations to allow the migration of polymer gel through the perforations when under compression. One such PTFE skin is Chemfilm T-100 Premium Skived Films from Saint Gobain. A sharp pin or needle may be used to make perforations therethrough.

Although the invention has been described with reference to a specific embodiment, this description is not meant to be construed in a limiting sense. On the contrary, various modifications of the disclosed embodiments will become apparent to those skilled in the art upon reference to the description of the invention. It is therefore contemplated that the appended claims will cover such modifications, alternatives, and equivalents that fall within the true spirit and scope of the invention.

1. A non-adhesive sealant, the sealant comprising:
a stretchable foam body, the body having an unstretched thickness of between 2 to 16 mil, the foam body having a first surface and a second surface;
a thin layer of cured polymer gel on the first surface of the foam body;
wherein a sealant first outer surface comprises the gel layer and a sealant second surface comprises the foam body second surface.

2. The non-adhesive sealant of claim 1, wherein the foam body is PTFE (polytetrafluoroethylene).

3. The non-adhesive sealant of claim 1, wherein the gel is a cured, tacky polyurethane gel.

4. The non-adhesive sealant of claim 1, wherein the gel layer is 1 to 8 mil thick, unstretched.

5. The non-adhesive sealant of claim 1, wherein the foam body is stretchable up to at least 100%.

6. The non-adhesive sealant of claim 1, wherein the foam body has pores, the pores being about 1 to 6 microns in size.

7. The non-adhesive sealant of claim 1, wherein the gel is a cured, tacky polyurethane gel; wherein the gel layer is 1 to 8 mil thick, unstretched; and wherein the foam body is stretchable up to at least 100%.

8. A non-adhesive sealant comprising:
an at least partially open cell foam carrier having an upper surface and a lower surface and a foam body between the upper and lower surface;
a cured, tacky, gel layer on at least one of the upper and lower surfaces of the foam carrier, the cured polyurethane gel layer at least partly penetrating the foam body, and
a skin engaging the foam carrier;
wherein the sealant has a smoke density of 200 maximum at about 4.0 minutes under AITM2-0007A, Issue 3.

9. The non-adhesive sealant of claim 8, wherein the sealant has a tackiness of between 5 and 50 psi measured on a side with the gel layer.

10. The non-adhesive sealant of claim 8, wherein the sealant passes 12 sec. vertical burn test according to 14 CFR, Part 25 § 25.853(a).

11. The non-adhesive sealant of claim 8, wherein the skin is impermeable.

12. The non-adhesive sealant of claim 8, wherein the skin is semi-permeable.

13. The non-adhesive sealant of claim 8, wherein the skin is non-stretchable.

14. The non-adhesive sealant of claim 8, wherein the tackiness is between 5 and 50 psi.

15. The non-adhesive sealant of claim 8, wherein the sealant is resistant to degradation by aircraft fluid.

16. A non-adhesive sealant comprising:
an at least partially open cell foam carrier having an upper surface and a lower surface and a foam body between the upper and lower surface;
a cured, tacky, gel layer on at least one of the upper and lower surfaces of the foam carrier, the cured polyurethane gel layer at least partly penetrating the foam body, and
a skin engaging the foam carrier;
wherein the sealant has toxicity limits of less than about: 150 PPM HCN, 1000 PPM CO, 100 PPM NO/NO2, 100 PPM SO2, 100 PPM HF, and 150 PPM HCl under AITM 3-0005, Issue 2.

17. The non-adhesive sealant of claim 16, wherein the sealant has a tackiness of between 5 and 50 psi measured on a side with the gel layer.

18. The non-adhesive sealant of claim 16, wherein the sealant passes 12 sec. vertical burn test according to 14 CFR, Part 25 §25.853(a).

19. The non-adhesive sealant of claim 16, wherein the skin is impermeable.

20. The non-adhesive sealant of claim 16, wherein the skin is semi-permeable.

21. The non-adhesive sealant of claim 16, wherein the skin is non-stretchable.

22. The non-adhesive sealant of claim 16, wherein the tackiness is between 5 and 50 psi.

23. The non-adhesive sealant of claim 16, wherein the sealant is resistant to degradation by aircraft fluid.
